(19) United States
(12) Patent Application Publication
(10) Pub. No.: US 2016/0224925 A1
(43) Pub. Date: Aug. 4, 2016

(54) SYSTEMS AND METHODS FOR CAPTURING AND ACTING ON WORKER ELECTRONIC DEVICE ACTIVITY

(71) Applicant: Spotlight Software, LLC, Phoenix, AZ (US)

(72) Inventors: Daniel Schulz, Peoria, AZ (US); Vincent Serpico, Phoenix, AZ (US); Donald Pierson, Phoenix, AZ (US)

(73) Assignee: Spotlight Software, LLC

(21) Appl. No.: 15/011,659

(22) Filed: Jan. 31, 2016

Related U.S. Application Data
(60) Provisional application No. 62/109,800, filed on Jan. 30, 2015.

(51) Int. Cl. G06Q 10/06

(52) U.S. Cl. CPC G06Q 10/06398

(57) ABSTRACT

Apparatus and methods for aggregating work activity information, application usage and/or self-reported work status designations are presented. Tracked activity information can be used to automatically determine worker status, or audit status designations manually submitted by workers. Reporting can be delivered to users (a) tracking activities and progress against predetermined objectives, and/or (b) comparing worker activities and progress against that of other workers. Worker activity information can be used by managers to evaluate and improve worker performance.

### TECHNICAL FIELD

The present disclosure relates in general to computing systems, and in particular to systems and methods for tracking use of electronic devices to monitor, evaluate and enhance worker productivity.

### BACKGROUND

Many modern job functions rely largely or entirely on electronic devices, such as mobile phones, computers and tablet computers. Meanwhile, workers use an increasingly diverse array of devices to perform their jobs, particularly with the proliferation of personal computing devices and even employer “Bring Your Own Device” policies, by which workers utilize their own electronic devices such as smartphones or tablet computers to perform work functions. Such a computing environment has been facilitated by the rise of cloud computing, whereby workers can frequently utilize centralized work systems seamlessly across numerous devices. For example, a sales worker may utilize a web-based CRM application and log into that application at various times from a work computer, a home computer, a tablet and their smartphone.

Optimally monitoring and managing the activities and performance of such a modern workforce can be challenging. While many centralized electronic systems provide reporting functionality, such reporting is frequently performed after-the-fact, based on limited sets of data surrounding events that happened in the past, and of limited utility in an environment with multiple, decentralized information systems.

### SUMMARY

In accordance with one aspect of the embodiments, device specific programming can be used to independently capture the activity and application usage of mobile and computing devices such as smart phones, tablets, desktop computers and wearable technology. Information is context sensitive and includes such information as the specific functions and applications each device is used for, as well as duration of use and resources used or accessed. Context can include information about the time and date the activity was recorded, where the device is located, who the device belongs to (e.g. unique user and/or device identification numbers) and if the device was in motion as well as specifics about the nature of motion.

For each device type, a specific program or code is written to interface with the operating system or directly with the hardware to monitor and collect the desired information in a standardized device independent format. Recorded information is either transmitted immediately, or collected and stored locally on the device for later transmission, to a centralized database for analysis, reporting and review. Information from multiple devices of the same user as well as extremely large numbers of other users can be collected and transmitted to the central database with the data being uniquely identifiable to each user, as well as each user's device even if they are being used simultaneously.

In addition to the automated collection of device activity and application usage, users can manually use the program to report one or more indicia of “status” that will also be collected and transmitted to the central database. Using the local device application, users can select from a list of defined status entries one most suited to describe what they are currently doing.

In addition to the automated collection of device activity and application usage, users can manually use the program to report specific predefined milestones, comments and various feedback that will also be collected and transmitted to the central database.

Using information collected, the application (potentially via interaction with the central database) can optionally automate and effect or cause to happen other desirable activities, based upon the context, location and status of the specific device in use. Such information can be used to automate the collection and update of user status information that would otherwise be manually specified.

Activity Characterization: Using standardized independently identifiable device activity and application usage data collected and stored in a centralized database, systems and methods are provided to determine if each entry is specifically applicable or unrelated to a targeted type of desired activity or behavior and use that information to improve effectiveness or productivity as it relates to that activity or behavior.

This can be accomplished by the use of either fixed or editable “white” and/or “black” lists of activities, as they relate to the target or desired activity or goal. Comparison and matching of collected activity information to defined “white” list usage data can be considered as positive affirmation of the desired activity or goal. Comparison and matching of collected information to the defined “black” list usage data can be considered as negative affirmation of the desired activity or goal. Collected information that matched neither “white” nor “black” list activities can be considered as undetermined, and held aside for manual review (such as by a manager or performance coach), allowing for exception handling while also driving opportunities for updating of either list.

Using this derived information, the system can establish and report a consolidated timeline of device activity and application usage, and determine if such is considered as either positive or negative affirmation of a desired activity or goal, for any individual user. Such individual data and determinations can be compared to other user's data for analysis, and used to provide recommendations as to what usage and activity patterns are most conducive toward the desired activity or goal for each user.

Further analysis of collected device and individual user activity against others can be used to establish base line characteristics. These baseline characteristics can then be used in connection with automated or manual coaching and training of users towards specific types of activities or behaviors that promote achievement of stated goals and levels of performance.

### BRIEF DESCRIPTION OF THE DRAWINGS

FIG. 1 is a schematic block diagram of a computing environment.

FIG. 2 is a schematic block diagram of a user computing device.

FIG. 3 is a schematic block diagram of a software stack.

FIG. 4 is a dashboard presented via web browser.

FIG. 5 is a dashboard with alternative, worker-specific status selectors.

FIG. 6 is a worker status designation configuration panel.

FIG. 7 is a web-based leader board display.

FIG. 8 is a mechanism for tracking worker progress versus objectives.

FIG. 9 is a mechanism for configuring automated notifications.

FIG. 10 is a web-based user interface for team time allocation reporting.

FIG. 11 is a web-based user interface for worker activity visualization.

FIG. 12 is a web-based user interface for worker activity visualization.

FIG. 13 is a reporting mechanism for aggregating activity information for multiple members of a team.

FIG. 14 is a reporting information for individual activity information.

FIG. 15 is a mobile app mechanism for submitting worker updates towards objectives.

FIG. 16 is a mobile leader board reporting mechanism.

FIG. 17 is a mechanism for submitting worker status designations.

FIG. 18 is a mobile objectives monitoring display.

### DETAILED DESCRIPTION OF THE DRAWINGS

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

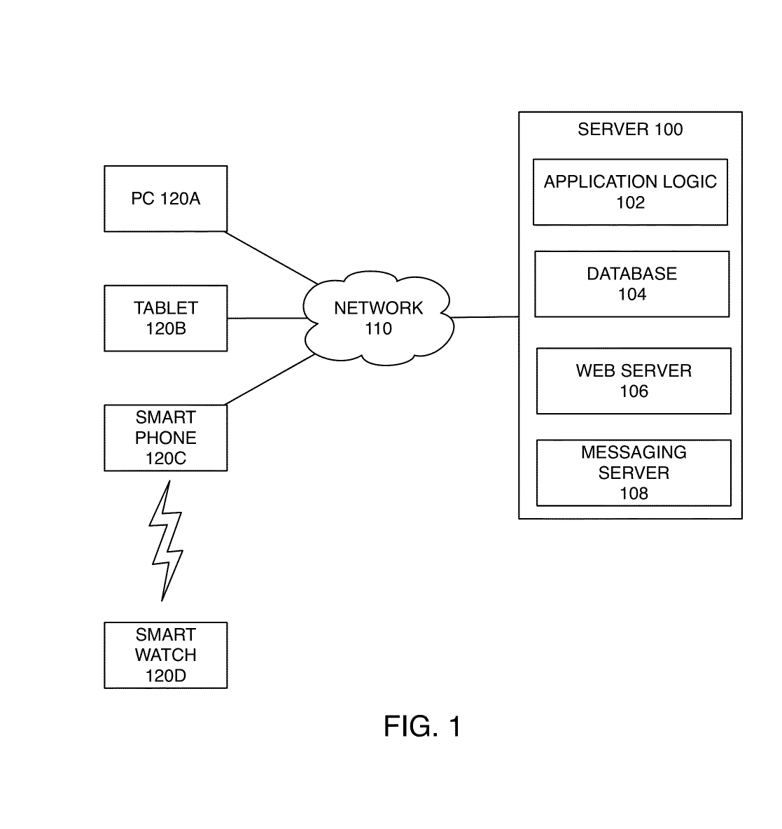

FIG. 1 is a schematic block diagram of an embodiment of a worker activity tracking system. Server 100 communicates, inter alia, via computer network 110, which may include the Internet, with user devices 120 such as personal computer 120A, tablet computer 120B, smart phone 120C and smart watch 120D. While FIG. 1 illustrates four user devices, it is contemplated and understood that implementations may include large numbers of user devices. For example, some implementations may include user devices for each of many workers within a corporation, and potentially multiple user devices of multiple different types for each worker. Server 100 implements application logic 102, and operates to store information within, and retrieve information from, database 104. The term “database” is used herein broadly to refer to a store of data, whether structured or not, including without limitation relational databases and document databases. Web server 106 hosts one or more Internet web sites enabling outside user interaction with, amongst other things, application logic 102 and database 104. Messaging server 108 enables instant messaging, such as SMS or MMS communications, between server 100 and user devices 120.

While depicted in the schematic block diagram of FIG. 1 as a block element with specific sub-elements, as known in the art of modern web applications and network services, server 100 may be implemented in a variety of ways, including via distributed hardware and software resources and using any of multiple different software stacks. Server 100 may include a variety of physical, functional and/or logical components such as one or more each of web servers, application servers, database servers, email servers, storage servers, SMS or other instant messaging servers, and the like. That said, the implementation of server 100 will include at some level one or more physical servers, at least one of the physical servers having one or more microprocessors and digital memory for, inter alia, storing instructions which, when executed by the processor, cause the server to perform methods and operations described herein.

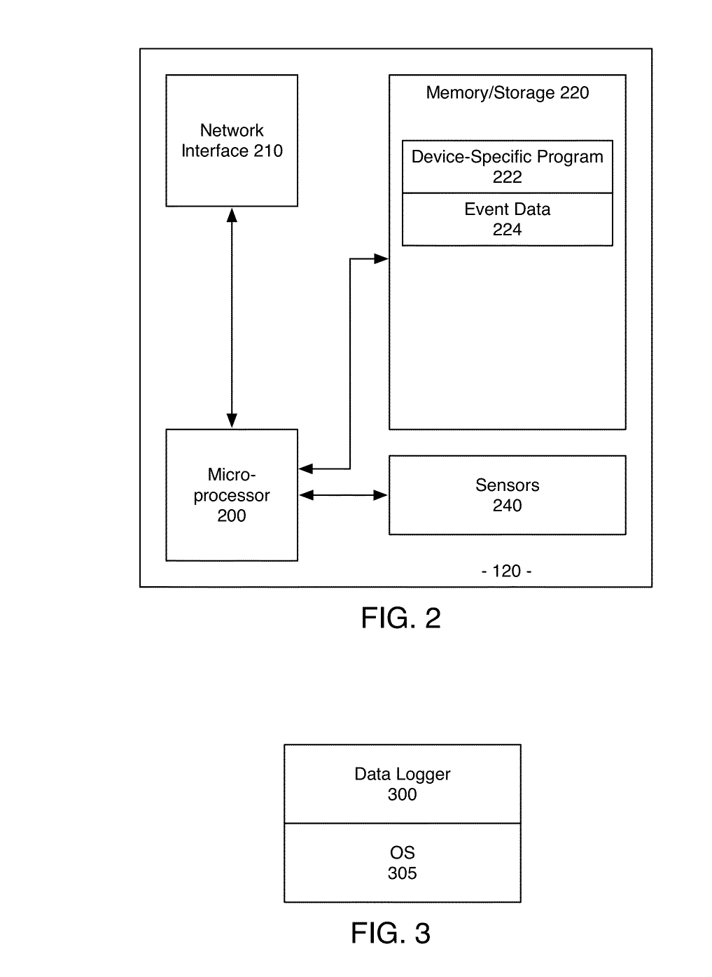

FIG. 2 is a schematic block diagram of an exemplary user device 120. User device 120 includes microprocessor 200, communicating externally via network interface 210 which may include one or more communication channels such as a wired or wireless Ethernet interface, Bluetooth, NFC, USB, or the like. Microprocessor 200 communicates with memory 220 and device sensors 240. Memory 220 may include, e.g., random access memory, SSD, hard disk drive, other types of digital storage, and combinations thereof. Sensors 240 may include device-specific sensors such as, in the case of smart phone 120C, temperature sensors, Global Positioning System (GPS) sensors, orientation sensors/accelerometers, ambient light sensors, audio transducers and the like.

In an embodiment, user devices 120 each include device-specific programming 222 stored within memory 220 and executed by microprocessor 200. The device specific programming 222 may be, for example: an application downloaded to and installed on a smart phone or tablet computer from an app store; or a software application installed on a laptop or desktop computer.

FIG. 3 is an exemplary software stack operating on user device 120 in accordance with one embodiment in which device-specific programming 222 implements a user activity tracker. In operation, data logger 300 operates to store event data related to the utilization of device 120 within memory 220, and specifically event data store 224. Operating system 305 provides, inter alia, functionality enabling interaction between data logger 300 and memory 220. Logged user event device data may include some or all of the following, without limitation: unique user and/or device ID, functions utilized within device 120, applications utilized within device 120, device resources used or accessed, event date and time of day, the duration of each event or usage, the device location (e.g. GPS coordinates), whether the device was in motion (as detected by an accelerometer and/or GPS), and the nature of device motion (as detected by accelerometer and/or GPS). Preferably, data is logged/recorded in a standardized, device-independent format.

In some embodiments, event data is stored only temporarily within data store 224, and is transmitted as soon as possible from device 120 back to server 100, e.g. for storage within database 104. In other use cases, event data is stored within data store 224 indefinitely, for later transmission to server 100, whether directly (e.g. via network 110) or indirectly (e.g. via syncing smart watch 120D to smart phone 120C using a near field wireless channel, for subsequent transmission to server 100 via network 110).

Numerous types of data can be beneficially logged by user devices 120 for subsequent transmission back to server 100. Typically, the types of data stored will be relevant to determining whether and how the user device is utilized in connection with the user's work functions. For example, in the case of a sales team management platform, smart phone 120C may log within event data store 224 information such as: incoming or outgoing phone calls (including the other parties involved, date and time of call, call duration, and call location), mobile web browser usage (including the duration of usage and web pages visited), mobile app usage, usage of email or other messaging applications (including the other parties involved in incoming or outgoing messages), etc.

Device specific program 222 may further include capabilities to enable users to manually input information relating to, e.g., their current activities. In some embodiments, a predetermined selection of status indicators will be made available to a user via user interface elements such as a drop-down menu. For example, in an application utilized to track activities of a sales team, status indicators may include, by without limitation: Coaching, Company Meetings, Customer Meetings, E-mail, Phone calls, Planning time, Presentation preparation, Product Management, Reports, Staff Meetings, and Travel. Manual status designations using user devices 120 are preferably immediately transmitted back to server 100.

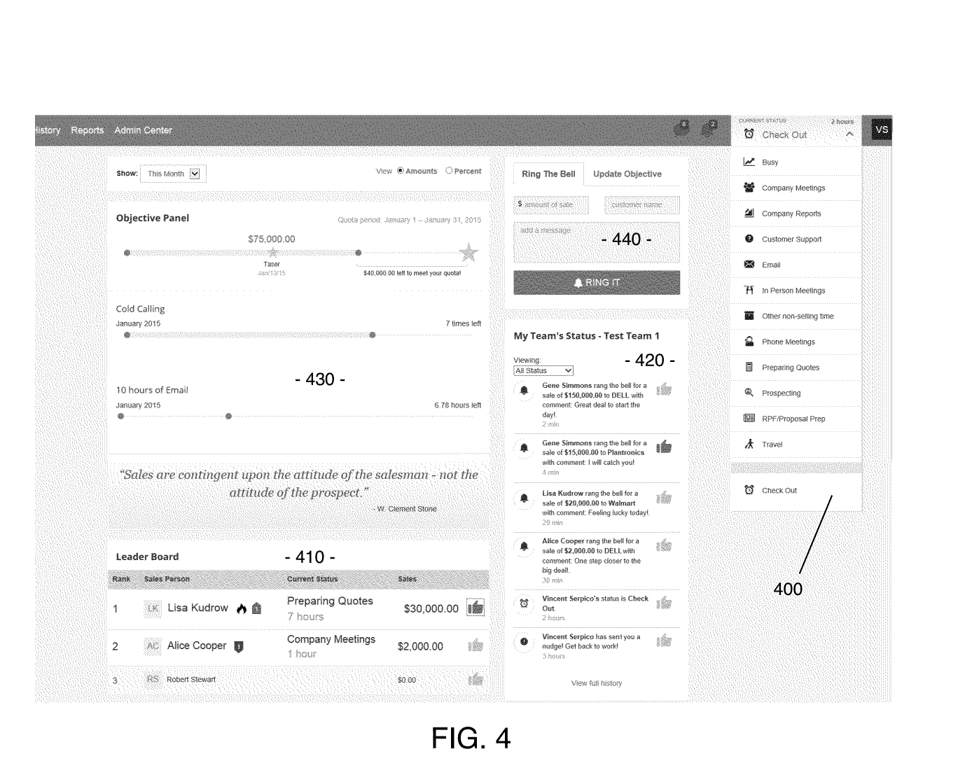

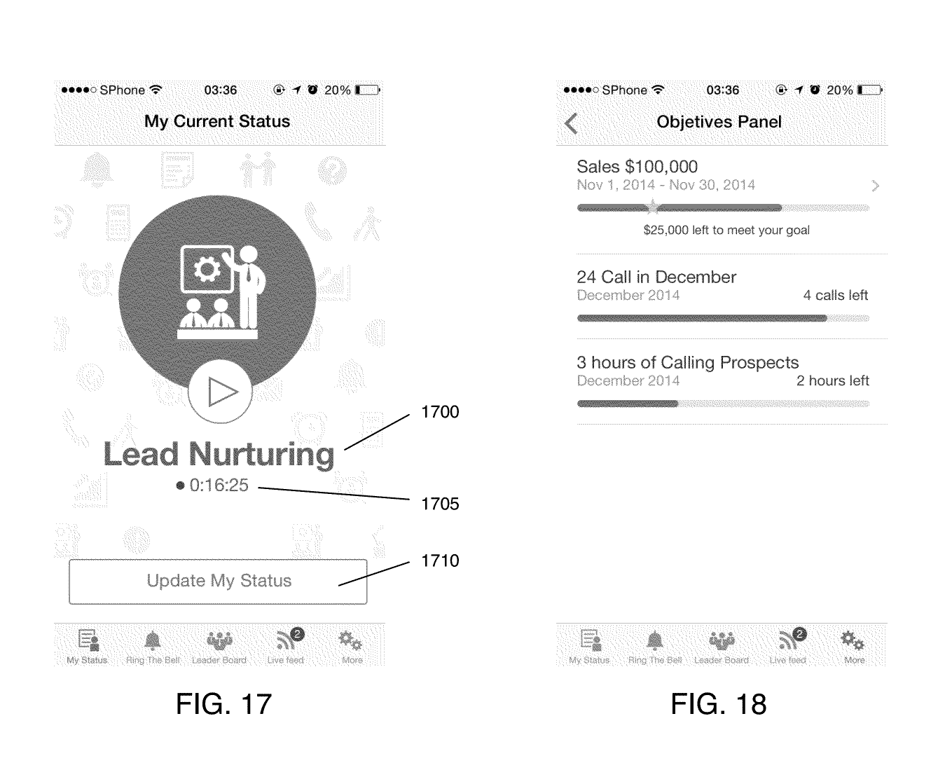

User interface mechanisms may be provided to facilitate manual designation of status information by an individual utilizing one of user devices 120. In a web browser-based user interface (shown in FIG. 4), drop down menu 400 may be provided as a user interface component via which users can select an appropriate current status description. FIG. 17 illustrates a mobile app user interface component, which may be implemented on smartphone 120C. Status designator 1700 indicates the status indicia currently selected as describing the user's activities (in this case, “Lead Nurturing”). Elapsed time indicia 1705 reflect the length of time that the user has been engaged in the activity type reflected by the current status indicator (in this case, zero hours, sixteen minutes and 25 seconds). Button 1710 can be actuated in order to change to a different status designation.

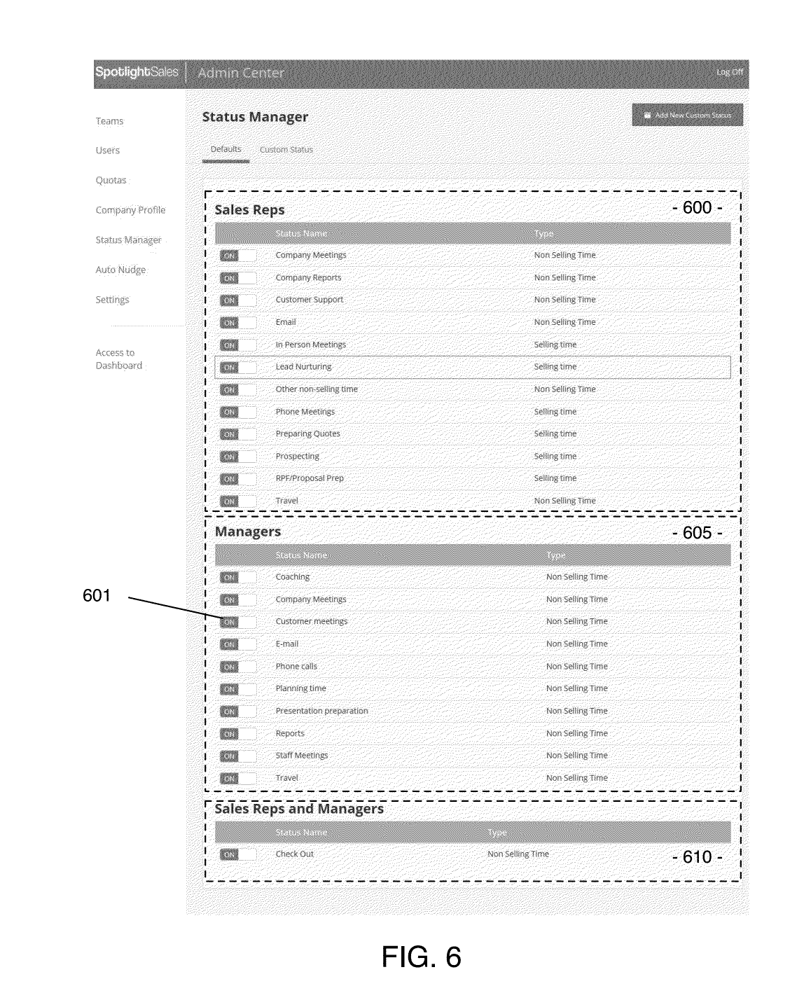

FIG. 6 illustrates an exemplary user interface rendered by server 100 within a web browser on a user device, whereby a user can configure status designations available to workers based on the worker role. Each of regions 600, 605 and 610 correspond to a different worker roles and contain a list of potential status designators, with switch indicia 601 provided to activate or deactivate the availability of an associated status designator for the corresponding worker role. Activated status designators are made available for selection by a user, e.g. via the user interface mechanisms of FIG. 4 (web) or FIG. 17 (mobile).

Data captured by user devices 120, whether automatic data logging or input manually by users, is then available for processing by server 100, and/or optionally for processing locally on user devices 120. Activity and Status data can be processed for several purposes. For example, activity information captured by data logger 300 on user devices 120 can be utilized to improve the accuracy and detail of user status information. In some embodiments, activity information may be processed locally on user device 120 by microprocessor 200 executing data logger application 300 to facilitate a user in accurately maintaining status designations. In some embodiments, activity information may be processed by server 100 after transmission from user device 120 in order to facilitate accurate status designation data.

Regardless of where activity-status correlation takes place, users may be prompted with real-time or after-the-fact user interface interactions suggesting updates to status designation, or correction of prior status designation. For example, in some embodiments, data logger 300 executing on smart phone 120C may determine that smart phone 120C is being utilized for telephone calls to customers, while also determining that the user's current status designation is set to Company Reports, in response to which the user may be prompted to consider updating their status, with specific suggestions of Phone Meetings or Customer Support. In some embodiments, a user interface mechanism may present selectable user interface indicia corresponding to suspected current status designations, as determined based on, inter alia, recent activity information stored in event data 224, such as a dialog box with buttons for “Change Status to Phone Meetings” and “Change Status To Customer Support”, thereby facilitating one-click confirmation of a user's suspected status indicator.

In other embodiments, server 100 may present users (or their managers) with a web-based user interface for reviewing a worker's historical activity information and comparing it against that worker's status designation over time, allowing the worker (or manager) to double-check status designation against actual activities and update the worker's status designation as necessary to more accurately correlate with the worker's actual activities. By improving the accuracy of Status designations, the value of the Status information can be significantly increased for purposes of, e.g., evaluating progress towards certain objectives, and providing coaching or training (whether automated or by team manager, as discussed further elsewhere herein).

Captured data may also be utilized to implement a team management portal, preferably via application logic 102 in operable connection with web server 106. In an employment context, the team management portal can be used to provide a manager or other individual with real-time insight into team member work activities, based at least in part on actual device utilization data (e.g. event data 224) compiled across potentially multiple devices associated with a particular individual. Thus, for example, as a sales worker moves from their office computer, to their smartphone, tablet computer, and portable laptop computer, all of the individual's activities are tracked and compiled into a comprehensive picture.

For example, FIG. 4 illustrates an exemplary manager dashboard presented via a web browser by web server 106, whereby a manager can view real-time information regarding the status of team members, based on information captured both automatically and manually, as described herein. Leader Board region 410 lists members, their current status, sales levels, and other information pertinent to their current activities. Region 420 provides real-time activity updates, based on worker activities collected and reported via utilization of user devices 120, as described above. Region 430 reports worker activity in terms of progress towards goals, again using real-time or near real-time data collection as described herein. Region 440 enables users to collaboratively message colleagues around important events, such as completion of sales. Pull down menu 400 provides multiple status designators, one of which may be selected by a user to indicate their current activities.

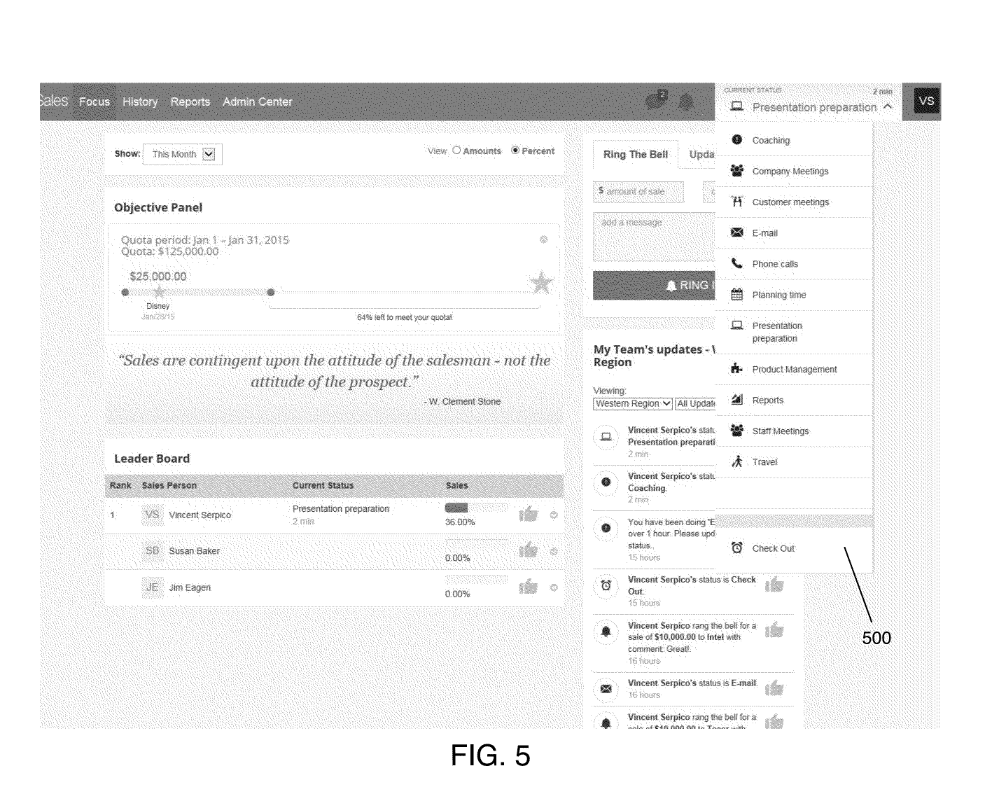

FIG. 5 illustrates an alternative dashboard view, as may be made available to a user having a different work role as compared to the dashboard of FIG. 4. Pull down status menu 500 again provides status designators that may be selected to indicate current activities, but the status designators differ from those of FIG. 4, and correspond to activities pertinent to the work role of the user of FIG. 5.

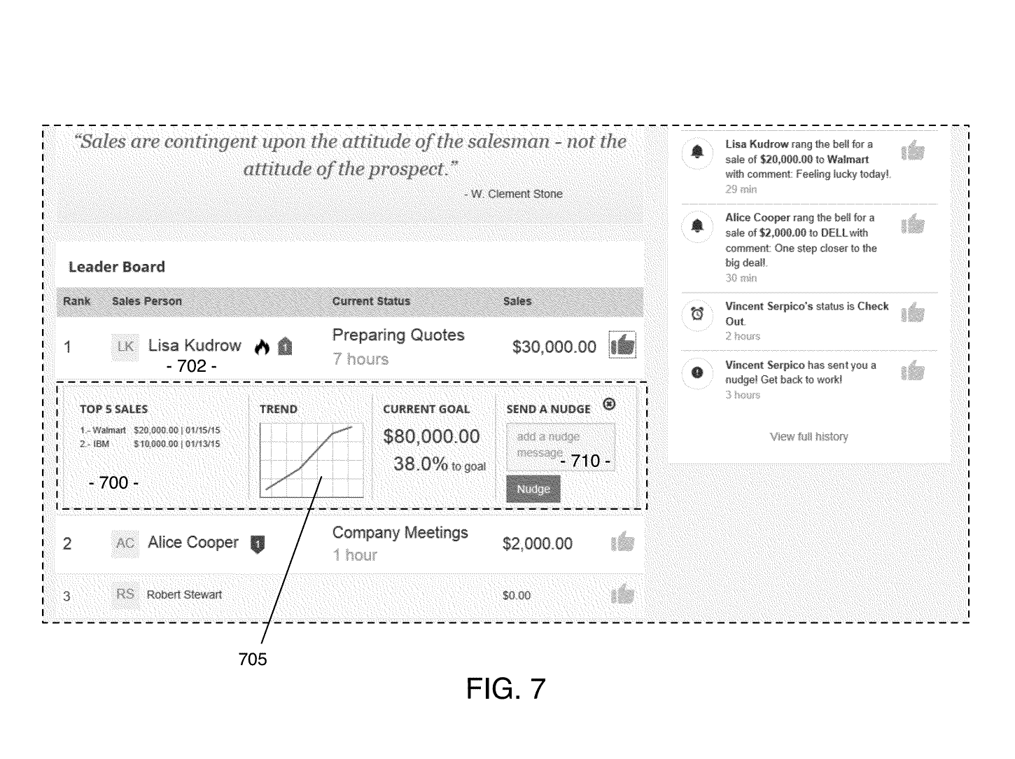

FIG. 7 illustrates a detail view rendered in Leader Board region 410. Selection of worker entry 702 reveals worker detail expansion region 700. Expansion region 700 provides additional information about the selected worker's activities, including trend line reporting 705 and Nudge user interface 710, as described further below.

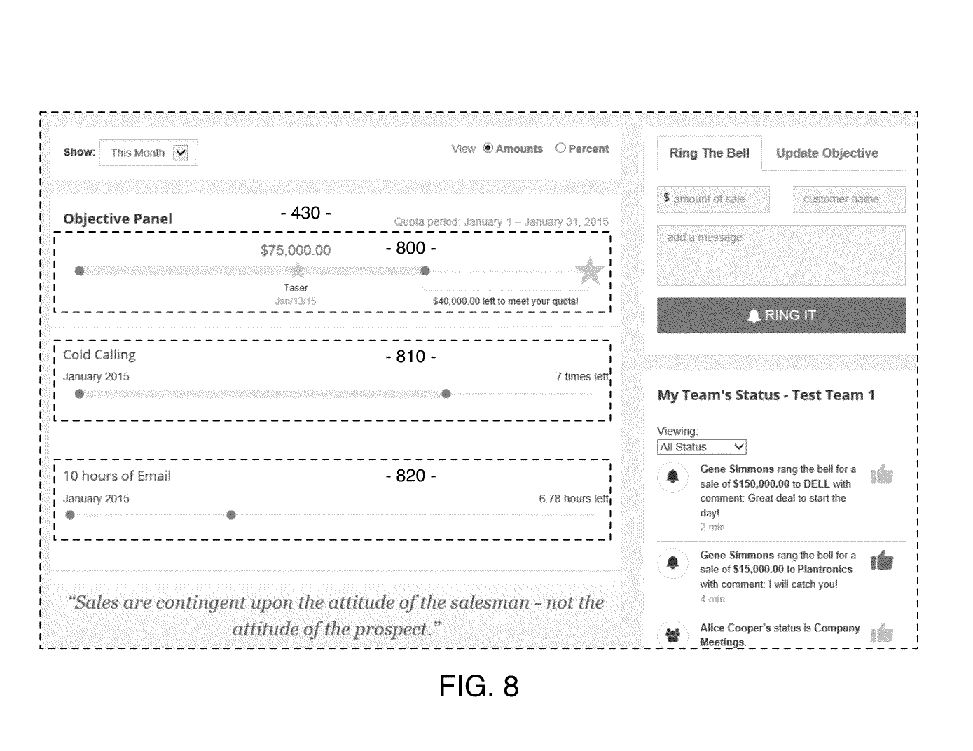

FIG. 8 illustrates an alternative dashboard view with focus on the Objective Panel 430. Objective panel 430 includes user interface components comparing actual worker activities (e.g. as may be measured automatically or designated manually, as described elsewhere herein) against goals for the worker. Goals may be determined, e.g., on an individual basis, on the basis of worker role, and/or collectively for a team. The embodiment of FIG. 8 provides an objective panel measuring worker activity against three objectives. Objective progress indicator 800 compares sales volume against a target metric, for a particular period of time (in this case, the current month). Objective progress indicator 810 compares the number of cold calling activities undertaken by a user, against a target objective for that activity. Objective progress indicator 820 compares the number of hours spent by a worker on email activities, against a target number of hours spent on email. Comparisons of actual user activity against targets can convey recommendations concerning the user's work activities. These and other objectives can be configured, for comparison with a worker's corresponding actual activity, as determined using, e.g., mechanisms described herein.

Server 100 also implements a Nudge feature, enabling targeted real-time messaging of workers. Managers can use the Nudge feature to encourage or coach team members or other workers, based on the manager's assessment of real-time activity and/or status information. Nudge sends an instant message to another worker's system user interface, such as a web browser popup message, or a message sent to a user's mobile phone or other mobile device via SMS or phone provider Notifications functionality. For example, if a manager determines that a sales rep has spent an entire day on email, the manager may use the nudge feature to send the worker a message suggesting they spend some time on prospecting or phone meetings.

Nudges can also be automated. For example, it may be desirable to notify a user if they have not changed their status for a predetermined period of time, to ensure that status reporting remains accurate and that the user has not switched activities without reporting a new status. Logged activity information can also be utilized as criteria for triggering a Nudge notification, such as in the case of a user reporting Phone Call status without having been using their telephone.

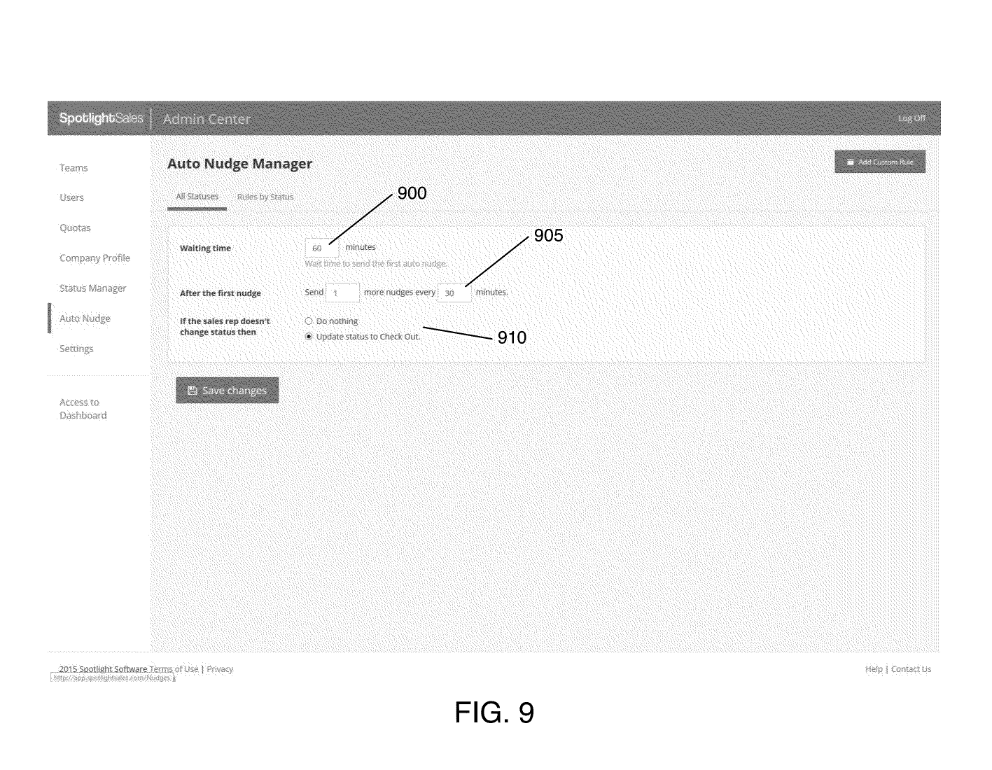

FIG. 9 illustrates an exemplary user interface for enabling a user to configure automatic Nudge notifications in response to the passing of a predetermined time period without status update. Field 900 enables configuration of an initial time period after last status designator reporting, after which a nudge notification is to be transmitted. Field 905 enables configuration of one or more periodic follow-up notifications, if the user continues to not update their status designation. Field 910 enables configuration of an automatic response, should the user continue to not update their status designation after the initial and follow-up notifications (e.g. do nothing, or authomatically sign out the user). The configuration of fields 900, 905 and 910 can be utilized by application logic 102 to control automated notifications between server 100 and user devices 120, and potentially an automated status change depending on the configuration of field 910.

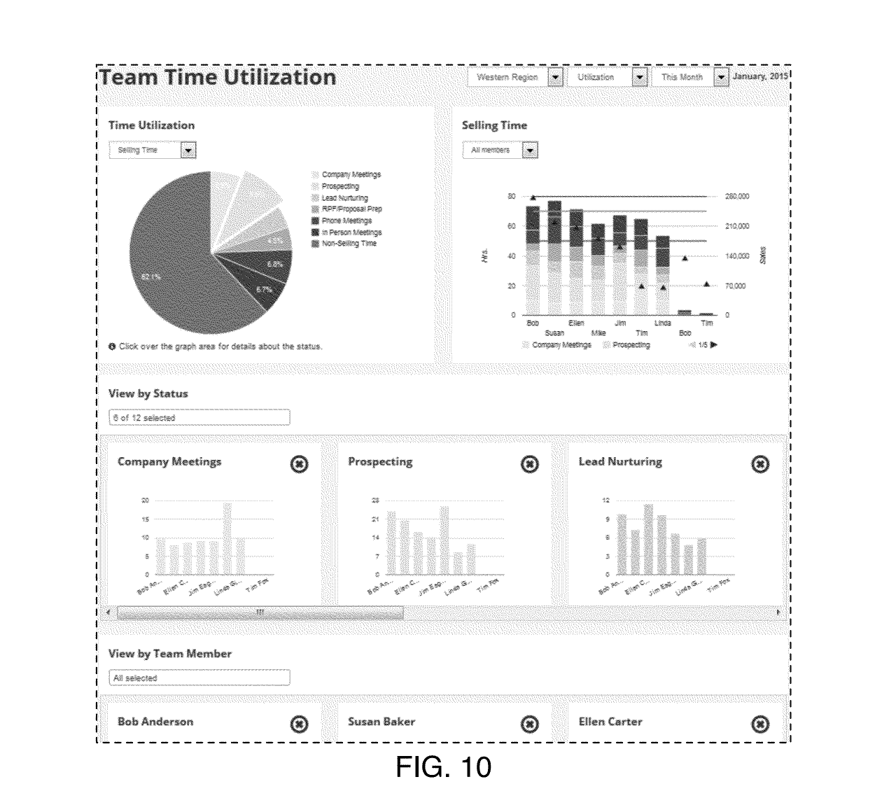

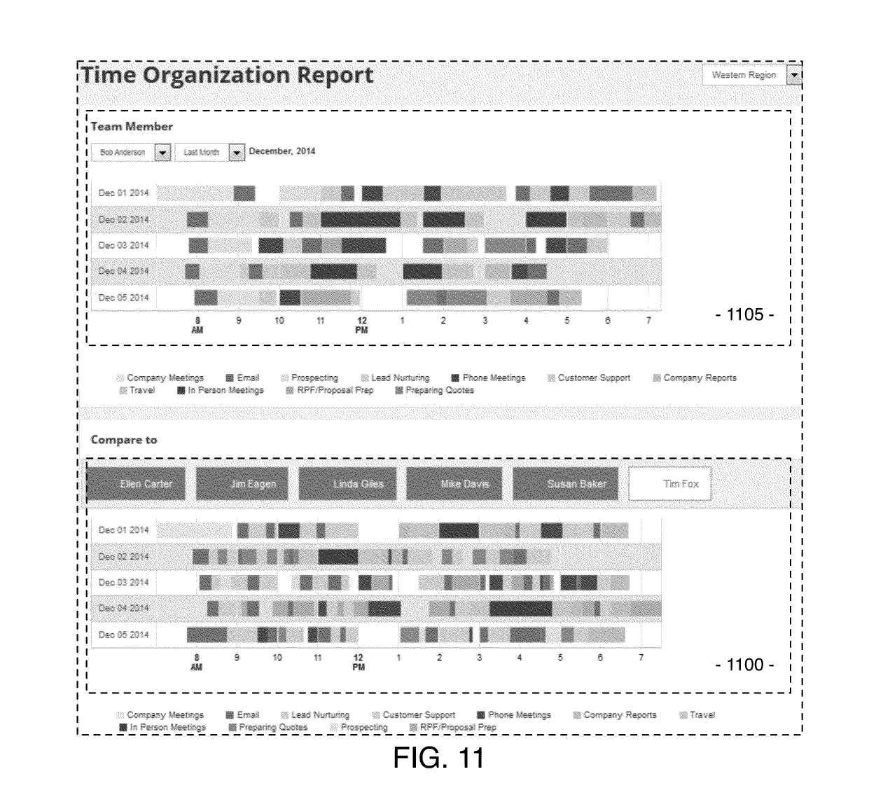

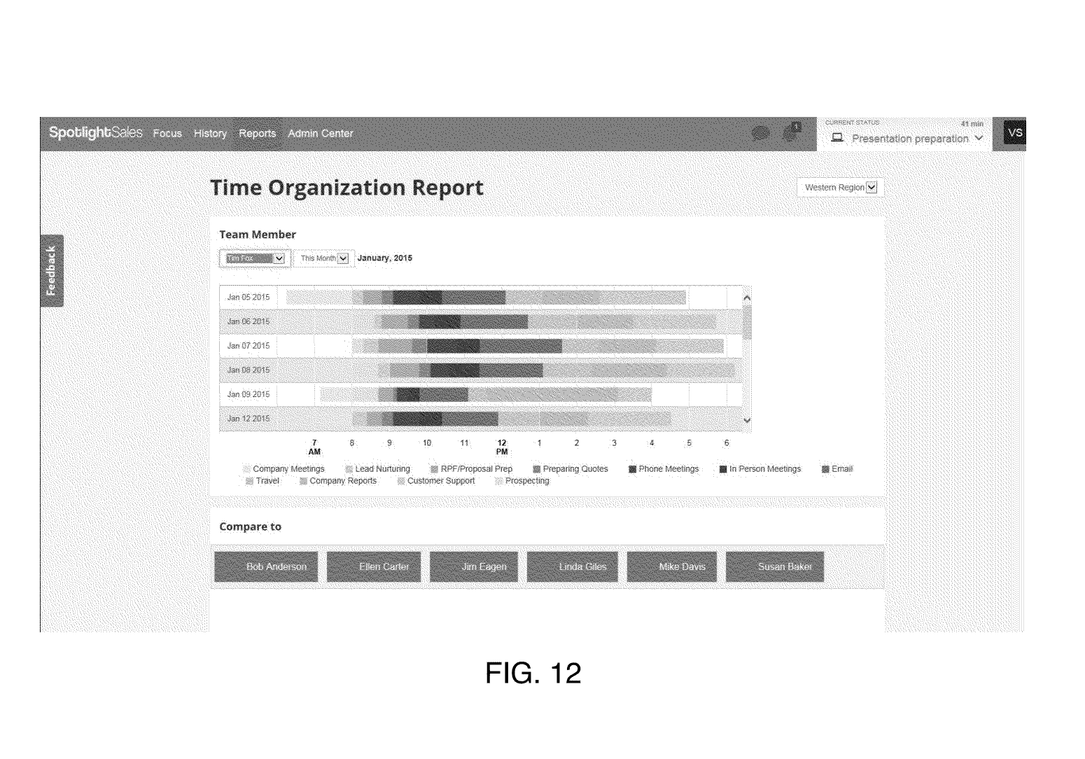

FIGS. 10-14 illustrate reporting user interfaces accessible to users, as may be rendered via a web browser operating on, e.g., personal computer user device 120A. For example, FIG. 10 provides visualizations of how worker team members are spending their time, based on e.g. Status information collected as described herein and aggregated across a team. FIGS. 11 and 12 provide visualizations of an activity timeline for workers throughout a day (horizontally), and across several days (with one row illustrated per day). In FIG. 11, lower region 1100 provides a user interface component enabling ready activity comparison of a subject worker's time utilization (depicted in upper region 1105) with the time utilization of various other workers during the same period of time (displayed in lower region 1100).

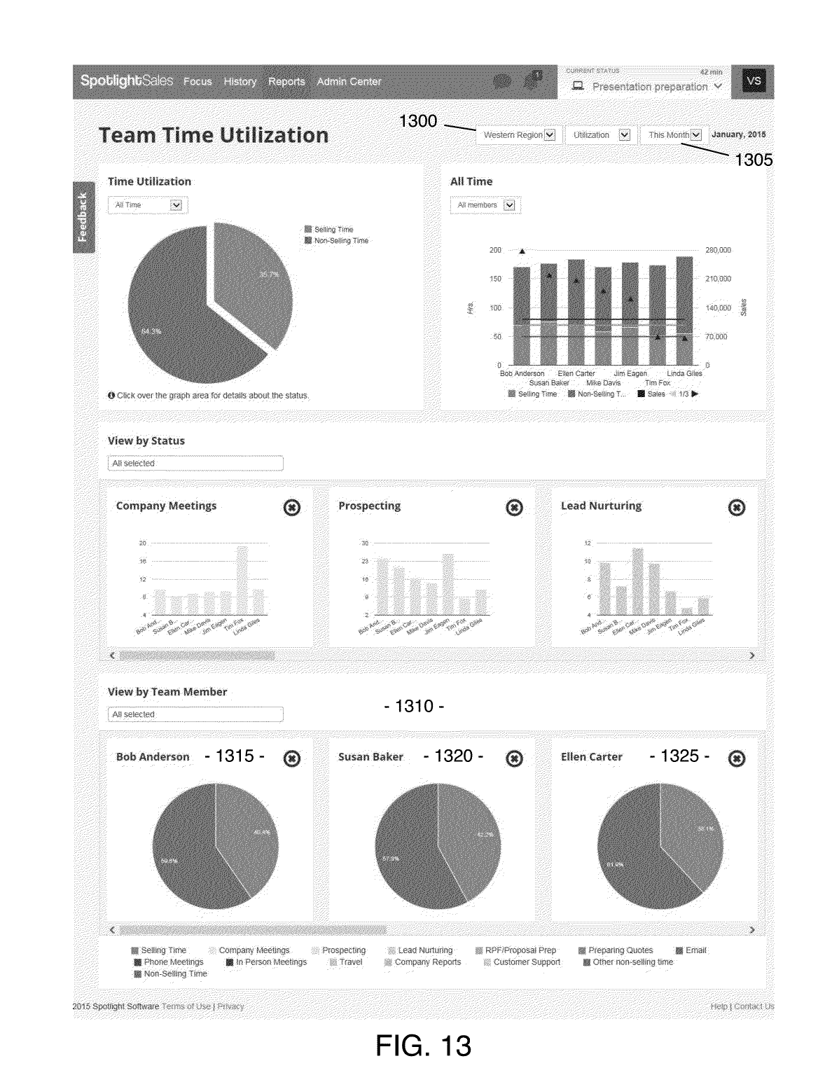

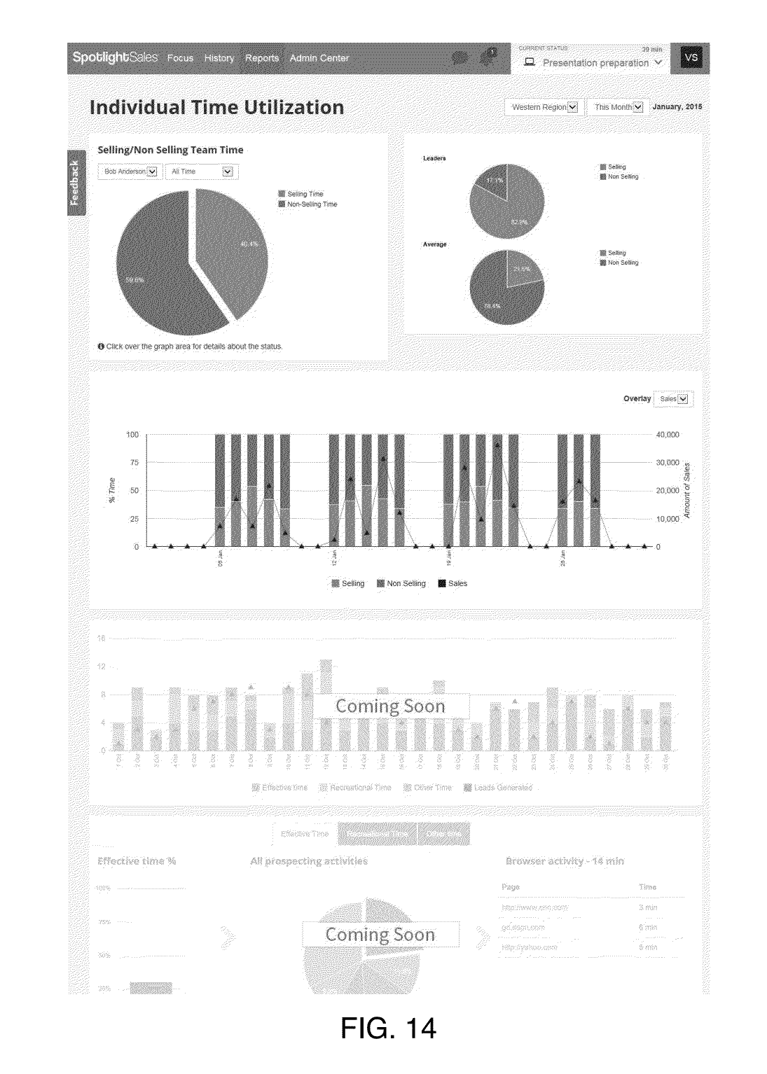

Activity information may also be aggregated across multiple workers, thereby enabling evaluation of aggregate team activities. FIG. 13 illustrates a reporting interface embodiment configured to aggregate activity information for multiple members of a team. Field 1300 enables selection of a preconfigured team for reporting, with the reflected activity information being an aggregation of activity information for all workers who are members of the selected team. Field 1305 enables selection of a time period for reporting. Team member region 1310 provides a user interface component with activity information corresponding to individual members of the selected team, including individual graphs 1315, 1320 and 1325. Any one of individual graphs 1315, 1320 or 1325 can be selected to generate a further detailed activity report corresponding to the selected individual, such as that illustrated in the embodiment of FIG. 14.

Reports such as those described herein can be used for worker management and activity optimization in several different ways. For example, in some embodiments, user activity analysis can be utilized by a worker's manager to receive real-time insight into the worker's activities and promptly provide encouragement or corrective action. In some embodiments, user activity analysis can be used to provide automated feedback to the worker, to help them achieve their goals. In some embodiments, in which server 100 is implemented as a multi-tenant Software As A Service application, data can be anonymously aggregated across companies to, e.g., identify correlations between user activities and performance or goal attainment. These correlations and aggregated insights can then be provided to users and/or managers to further optimize their user performance.

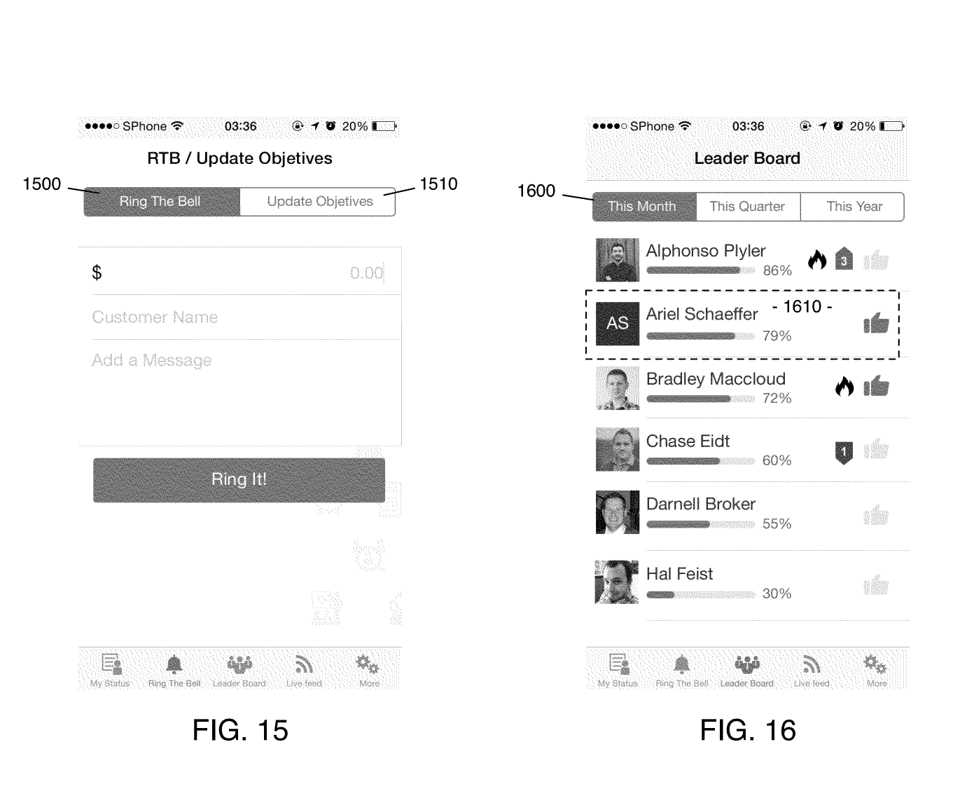

In accordance with another embodiment, FIGS. 15-18 illustrate a user interface rendered by a smart phone app such as would be executed by user device 120C. Information presented via the user interfaces of FIGS. 15-18 can be retrieved locally (e.g. from memory 220 and event data 224), remotely (e.g. from server 100 and database 104, communicating with user device 120 via network 110), or some combination thereof.

The user interface embodiment of FIG. 15 provides a user interface component facilitating entry of real time updates by workers, particularly in a sales organization. Selection of “Ring The Bell” indicia 1500 presents form 1505, via which a worker can (in real time) input information indicative of a new customer sale. Selection of “Update Objective” indicia 1510 presents another form (not shown), via which a worker can input information indicative of progress towards objectives previously configured for them, which may be subsequently reported on by, e.g., the reporting mechanism of FIG. 8.

FIG. 16 provides a mobile Leader Board communicating real time status of team members towards goals, analogous to Leader Board 410 in the web browser embodiment of FIG. 4. Time frame bar 1600 enables selection of a time frame over which reported information is compiled. Each report line 1610 presents information associated with one team member, including percentage completion of objectives, over the selected reporting period.

FIG. 17 is a mobile user interface for reporting current worker status, as described further hereinabove. FIG. 18 provides a mobile Objectives Panel via which a worker can monitor their progress towards objectives in real time, analogously to objectives panel 430 in FIG. 4.

In some embodiments, user activity data is analyzed against target or desired activities to evaluate user activity against a goal. For example, in the context of a sales team management system, a company may analyze real-time logged activities of top sales performers and establish optimal goals for activity mix throughout a period of time (e.g. average hours per week spent meeting with customers, calling customers, prospecting for new customers, emailing, meeting internally, in office, out of office, and the like). Each user's own activities can then be compared against the optimal mix, such that significant deviations can be flagged and managed.

In some embodiments, various activities can be categorized into a “white list” of activities that are desired and/or conducive towards a goal; and a “black list” of activities that are undesired and/or not conducive towards a goal. User activities logged on user devices 120 and transmitted to server 100 can then be analyzed against the white and black lists to evaluate how much of a user's activity is conducive or not conducive towards their goals.

In some embodiments, activities that do not fall within predetermined white list or black list activity categories may be flagged as Undetermined or Grey List. Optionally, a worker's manager can review a feed of Undetermined activities and manually designate the activity as White Listed or Black Listed. Preferably, such designations can be automatically applied to future instances of the same or analogous activities.

In some embodiments, White List, Black List and adjudications of Undetermined activities can be maintained on a group basis, whereby determinations are applied to all workers. In other embodiments, activity categorization can be applied based on worker category, such that, for example, salespeople may have different White List and Black List activities than executive management. In yet other embodiments, activity categorization can be applied on an individual worker basis. In yet other embodiments, user-selected combinations of global, worker type and individual determinations can be implemented for activity categorization. Such activity categorization can be performed by server 100, in particular application logic 102, and reported to users via, e.g., web browser or mobile app user interface, as described elsewhere herein.

While certain system infrastructure elements are illustrated in particular configurations, it is understood and contemplated that functional elements can be readily integrated and/or implemented via various alternative hardware or software abstractions, as would be known to a person of skill in the field of information systems design. For example, while some of the above described embodiments include presentation of content via a web browser, it is contemplated and understood that a standalone PC application, or a smart phone or tablet computer app, could be implemented in order to present content as described hereinabove. These and other variations are contemplated.

Moreover, while certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the invention or appended claims.

I claim:

1. An apparatus for evaluating activities undertaken by one or more users, each utilizing one or more electronic user devices, comprising:
a user computing device having a display screen, said device further having a microprocessor implementing one or more client software applications, said device being configured for communication via the Internet;
an activity tracker implemented by the microprocessor, the activity tracker logging activity information related to a user's use of the user computing device;
a first user interface component presented on said user computing device display screen by the client software application, selection of said first user interface component by the user specifying a user work status that is stored within apparatus memory and communicated to a central server via the Internet; and
a second user interface component presented on said user computing device display screen by the client software application, the second user interface component presenting recommendations concerning the user's work activities in response to analysis of information comprising one or more characteristics of the user's activity information.

2. The apparatus of claim 1, in which the analysis of one or more characteristics of the user's activity information is performed via the microprocessor.

3. The apparatus of claim 1, in which the analysis of one or more characteristics of the user's activity information is performed via the central server and communicated to the apparatus via the Internet.

4. The apparatus of claim 1, in which the one or more characteristics of the user's activity information comprises information descriptive of smart phone usage.

5. The apparatus of claim 1, in which the user's activity information further comprises information from multiple user devices aggregated by a central server and conveyed to the apparatus via the Internet.

6. The apparatus of claim 1, further comprising a third user interface component conveying information comparing activity information associated with a user of the user computing device, with activity information associated with other users aggregated by a central server and conveyed to the apparatus via the Internet.

7. The apparatus of claim 6, in which the activity information associated with other users comprises anonymized activity information associated with users outside an organization with which the user is associated.

8. The apparatus of claim 1, further comprising a third user interface component via which a user can report information associated with progress towards completing previously-configured work objectives.

9. A computer-implemented method for evaluating sales team activity, the sales team comprising a plurality of members, the method comprising:
receiving and storing within a database, by a centralized network-connected server: (a) automatically logged information indicative of activities undertaken by members of the sales team using one or more electronic user devices, and (b) member-specified information indicative of member work activities during a period of time;
generating metrics derived from the automatically-logged information and/or manually-specified information; and
comparing said automatically-logged information and manually-specified information to target metrics, to identify one or more recommendations to assist a member in conforming the member's actual work activities to said target metrics.

10. The computer-implemented method of claim 9, in which the step of comparing said automatically-logged information and manually-specified information to target metrics is performed automatically by application logic implemented by the centralized network-connected server.

11. The computer-implemented method of claim 9, in which the step of comparing said automatically-logged information and manually-specified information to target metrics is performed by a manager viewing reports generated by the centralized network-connected server and delivered to a manager's user device.

12. The computer-implemented method of claim 9, further comprising:
generating a report comparing work activities associated with a first member of the team, with work activities associated with a second member of the team.

13. The computer-implemented method of claim 9, further comprising:
generating a report comparing work activities associated with a first member of the team, with average work activity information aggregated from a plurality of team members and stored within the database.

14. The computer-implemented method of claim 9, further comprising:
generating a report comparing work activities associated with a first member of the team, with anonymized work activity information stored within the database and aggregated from a plurality of workers, at least some of the workers being associated with an entity other than that of the sales team.

15. A computer-implemented method for evaluating worker activities relative to a goal, the method comprising:
receiving and storing within a database, by a central network-connected server, a log of activities undertaken by a worker using one or more electronic user devices, information for the log being automatically collected by the electronic devices;
hosting by the central server a white list of activities deemed conducive towards a goal, and a black list of activities deemed not conducive towards the goal; and
comparing, by the central server, the log of worker activities to the white list and the black list, to generate a report evaluating an amount of the worker's activity that is conducive towards the goal.

16. The computer-implemented method of claim 15, further comprising the step of transmitting the report to a manager of the worker.

17. The computer-implemented method of claim 15, further comprising:
identifying one or more logged worker activities represented in neither the white list nor the black list; and
presenting the unrepresented activities to a manager for evaluation of conductivity towards the goal.
